(19) United States
(12) Patent Application Publication
(10) Pub. No.: US 2006/0188723 A1
(43) Pub. Date: Aug. 24, 2006

(54) Coating compositions containing single wall carbon nanotubes

(75) Inventors: Lawrence A. Rowley, Rochester, NY (US); Glen C. Irvin JR., Rochester, NY (US); Charles C. Anderson, Penfield, NY (US); Debasis Majumdar, Rochester, NY (US)

Correspondence Address: Paul A. Leipold;Eastman Kodak Company, 343 State Street, Rochester, NY, 14650-2201, US

(73) Assignee: Eastman Kodak Company

(21) Appl. No.: 11/062,418

(22) Filed: Feb. 22, 2005

(51) Int. Cl. D01F 9/12; C09C 1/44; B32B 9/00

(52) U.S. Cl. 428/408; 423/447.2; 977/746; 106/472; 428/409

(57) ABSTRACT

The present invention relates to a coating composition comprising an aqueous dispersion of single wall carbon nanotubes with covalently attached hydrophilic species selected from the group consisting of carboxylic acid, nitrates, hydroxyls, sulfur containing groups, carboxylic acid salts, and phosphates, in an amount of at least 0.5 atomic % of said carbon nanotubes, wherein said carbon nanotubes are present in an amount of at least 0.05 wt. % of said dispersion.

### FIELD OF THE INVENTION

The present invention relates to a method of dispersing single wall carbon nanotubes in substantially aqueous systems to produce stable dispersions at solids loadings suitable for coating methods commonly employed in making thin films or patterned features.

### BACKGROUND OF THE INVENTION

Single wall carbon nanotubes (SWCNTs) are essentially graphene sheets rolled into hollow cylinders thereby resulting in tubules composed of sp² hybridized carbon arranged in hexagons and pentagons, which have outer diameters between 0.4 nm and 10 nm. These SWCNTs are typically capped on each end with a hemispherical fullerene (buckyball) appropriately sized for the diameter of the SWCNT. Although, these end caps may be removed via appropriate processing techniques leaving uncapped tubules. SWCNTs can exists as single tubules or in aggregated form typically referred to as ropes or bundles. These ropes or bundles may contain several or a few hundred SWCNTs aggregated through Van der Waals interactions forming triangular lattices where the tube-tube separation is approximately 3-4 Å. Ropes of SWCNTs may be composed of associated bundles of SWCNTs.

The inherent properties of SWCNTs make them attractive for use in many applications. SWCNTs can possess high (e.g. metallic conductivities) electronic conductivities, high thermal conductivities, high modulus and tensile strength, high aspect ratio and other unique properties. Further, SWCNTs may be either metallic, semi-metallic, or semiconducting dependant on the geometrical arrangement of the carbon atoms and the physical dimensions of the SWCNT. To specify the size and conformation of single-wall carbon nanotubes, a system has been developed, described below, and is currently utilized. SWCNTs are described by an index (n, m), where n and m are integers that describe how to cut a single strip of hexagonal graphite such that its edges join seamlessly when the strip is wrapped into the form of a cylinder. When n=m e.g. (n,n), the resultant tube is said to be of the “arm-chair” or (n, n) type, since when the tube is cut perpendicularly to the tube axis, only the sides of the hexagons are exposed and their pattern around the periphery of the tube edge resembles the arm and seat of an arm chair repeated n times. When m=0, the resultant tube is said to be of the “zig zag” or (n,0) type, since when the tube is cut perpendicular to the tube axis, the edge is a zig zag pattern. Where n≠ m and m≠0, the resulting tube has chirality. The electronic properties are dependent on the conformation, for example, arm-chair tubes are metallic and have extremely high electrical conductivity. Other tube types are metallic, semimetals or semi-conductors, depending on their conformation. SWCNTs have extremely high thermal conductivity and tensile strength irrespective of the chirality. The work functions of the metallic (approximately 4.7 eV) and semiconducting (approximately 5.1 eV) types of SWCNTs are different.

Similar to other forms of carbon allotropes (e.g. graphite, diamond) these SWCNTs are intractable and essentially insoluble in most solvents (organic and aqueous alike). Thus, SWCNTs have been extremely difficult to process for various uses. Often, it may be desired to utilize SWCNTs in a pristine state, that is, a state where the SWCNTs are essentially free from defects or surface (internal or external) functionality. Such pristine tubes are intractable in most solvents, and especially aqueous systems. Several methods to make SWCNTs soluble in various solvents have been employed. One approach is to covalently functionalize the ends of the SWCNTs with either hydrophilic or hydrophobic moieties. A second approach is to add high levels of surfactant and/or dispersants (small molecule or polymeric) to help solubilize the SWCNTs.

Haddon et al. in U.S. Pat. No. 6,368,569 disclose a method to solubilize SWCNT and multi-wall carbon nanotubes (MWCNTs) into organic solvents (THF, dichlorobenzene, DMF, chloroform, benzene, toluene etc.) via attaching covalently to the single or multi-wall carbon nanotubes long branched or unbranched aliphatic chains such as long chain amines (e.g. dodecylamine, pentacosylamine etc.). The use of organic solvents is not desired due to costs of the solvents, and hazardous nature of such solvents described above. Further, organic solvents typically add costs in processing streams for removal/disposal. The long chain aliphatics are not desired due to the potential of adding high levels of chemical material that are not useful for the uses intended and may interfere with the material properties of the SWCNTs. Such long chain aliphatics may be removed in a post-processing step but such steps add undesired cost and time.

In a recent publication titled Synthesis and Properties of a Water-Soluble Single-Walled Carbon Nanotube-Poly(m-aminobenzene sulfonic acid) (PABS) Graft Copolymer by Bin Zhao, Hui Hu, and Robert Haddon in journal article Advanced Functional Materials 2004, Volume 14, Number 1, p. 71 disclose compositions for functionalized SWCNT electronically conducting materials. Zhao discloses SWCNTs that have PABS covalently grafted onto the walls of the SWCNTs. The conductivity of this functionalized SWCNT was found to be 5.6×10⁻³ S/cm, which is not sufficient for electronic devices.

Connell et al in US Patent Application Publication 2003/0158323 A1 describes a method to produce polymer/SWCNT composites that are electrically conductive and transparent. The polymers (polyimides, copolyimides, polyamide acid, polyaryleneether, polymethylmethacrylate) and the SWCNTs or MWCNTs are mixed in organic solvents (DMF, N,N-dimethlacetamide, N-methyl-2-pyrrolidinone, toluene,) to cast films that have conductivities in the range of 10⁻⁵-10⁻¹² S/cm with varying transmissions in the visible spectrum. Additionally, monomers of the resultant polymers may be mixed with SWCNTs in appropriate solvents and polymerized in the presence of these SWCNTs to result in composites with varying weight ratios. The conductivities achieved in these polymer composites are several orders of magnitude too low and not optimal for use in most electronic devices as electronic conductors or EMI shields. Addtionally, the organic solvents used are hazardous, costly and pose problems in processing. Moreover, the polymers used or polymerized are not conductive and can impede tube-tube contact further increasing the resistivity of the composite.

Kuper et al in Publication WO 03/060941A2 disclose compositions to make suspended carbon nanotubes. The compositions are composed of liquids and SWCNTs or MWCNTs with suitable surfactants (cetyl trimethylammonium bromide/chloride/iodide). The ratio by weight of surfactant to SWCNTs given in the examples range from 1.4-5.2. This method is problematic, as it needs extremely high levels of surfactant to solubilize the SWCNTs. The surfactant is insulating and impedes conductivity of a film deposited from this composition. The surfactant may be washed from the film but this step adds complexity and may decrease efficiency in processing. Further, due to the structure formed from a film deposited from such a composition, it would be very difficult to remove all the surfactant.

Smalley et al in U.S. Pat. No. 6,645,455 disclose methods to chemically derivatize SWCNTs to facilitate solvation in various solvents. Primarily the various derivative groups (alkyl chains, acyl, thiols, aminos, aryls etc.) are added to the ends of the SWCNTs. The side-walls of the SWCNTs are functionalized primarily with fluorine groups resulting in fluorinated SWCNTs. The solubility limit of such “fluorotubes” in 2-propanol is approximately 0.1 mg/mL and in water or water/acetone mixtures the solubility is essentially zero. The fluorinated SWCNTs were subjected to further chemical reactions to yield methylated SWCNTs and these tubes have a low solubility in Chloroform but not other solvents. Such low concentrations are impractical and unusable for most deposition techniques useful in high quantity manufacturing. Further, such high liquid loads need extra drying considerations and can destroy patterned images due to intermixing from the excess solvent. In addition, the method discloses functionalization of the tubule ends with various functionalization groups (acyl, aryl, aralkyl, halogen, alkyl, amino, halogen, thiol) but the end functionalization alone may not be enough to produce viable dispersions via solubilization. Further, the side-wall functionalization is done with fluorine only, which gives limited solubility in alcohols, which can make manufacturing and product fabrication more difficult. Additionally, the fluorinated SWCNTs are insulators due to the fluorination and thereby are not useful for electronic devices especially as electronic conductors. Moreover, the chemical transformations needed to add these functional groups to the end points of the SWCNTs require additional processing steps and chemicals which can be hazardous and costly.

Smalley et al. in U.S. Pat. No. 6,683,783 disclose methods to purify SWCNT materials resulting in SWCNTs with lengths from 5-500 nm. Within this patent, formulations are disclosed that use 0.5 wt % of a surfactant, Triton X-100 to disperse 0.1 mg/mL of SWCNT in water. Such low concentrations of SWCNTs are impractical and unusable for most deposition techniques useful in high quantity manufacturing. Further, such high liquid loads need extra drying considerations and can destroy patterned images due to intermixing from the excess solvent. In addition, the method discloses functionalization of the tubule ends with various functionalization groups (acyl, aryl, aralkyl, halogen, alkyl, amino, halogen, thiol) but the end functionalization alone may not be enough to produce viable dispersions via solubilization. Moreover, the chemical transformations needed to add these functional groups to the end points of the SWCNTs require additional processing steps and chemicals which can be hazardous and costly. Also, the patent claims a composition of matter, which is at least 99% by weight of single wall carbon molecules which obviously limits the amount of functionalization that can be put onto the SWCNTs thereby limiting its solubilization levels and processability.

Elkovitch in US Patent Application 2004/0232389A1 discloses conductive compositions produced by dry compounding of carbon nanotubes into a polymer resin using a nanosized dispersing aid. This method is disadvantaged as it only uses dry mixing methods to form the composite, limiting the dispersion effectiveness. Additionally, to disperse the carbon nanotubes well in the polymer matrix, nanoparticles (clays, metal oxides) are used which increases cost.

Rinzler et al. in PCT Publication WO2004/009884 A1 disclose a method of forming SWCNT films on a porous membrane such that it achieves 200 ohms/square and at least 30% transmission at a wavelength of 3 um. This method is disadvantaged since it needs a porous membrane (e.g. polycarbonate or mixed cellulose ester) with a high volume of porosity with a plurality of sub-micron pores as a substrate which may loose a significant amount of the SWCNT dispersion through said pores thereby wasting a significant amount of material. Also, such membranes may not have the optical transparency required for many electronic devices such as displays. Further, the membrane is set within a vacuum filtration system which severely limits the processability of such a system and makes impossible roll coating application of the SWCNT solution. Moreover, the weight percent of the dispersion used to make the SWCNT film was 0.005 mg/mL in an aqueous solution. Such weight percents are impractical and unusable in most coating and deposition systems with such a high liquid load. Such high liquid loads make it virtually impossible to make patterned images due to solvent spreading and therefore image bleeding/destruction.

Chen in EP1359169A2 and EP1359121A2 disclose materials and methods to solubilize SWCNTs. Rigid backbone polymers are described that are used to noncovalently bond with a carbon nanotube substantially along the nanotube's length, as opposed to about its diameter.

Arthur et al in PCT Publication WO 03/099709 A2 disclose methods for patterning carbon nanotubes coatings. Dilute dispersions (10 to 100 ppm) of SWCNTs in isopropyl alcohol (IPA) and water (which may include viscosity modifying agents) are spray coated onto substrates. After application of the SWCNT coating, a binder is printed in imagewise fashion and cured. Alternatively, a photo-definable binder may be used to create the image using standard photolithographic processes. Materials not held to the substrate with binder are removed by washing. Dilute dispersions (10 to 100 ppm) of SWCNTs in isopropyl alcohol (IPA) and water with viscosity modifying agents are gravure coated onto substrates. Dilute dispersions (10 to 100 ppm) of SWCNTs in isopropyl alcohol (IPA) and water are spray coated onto substrates. The coated films are then exposed through a mask to a high intensity light source in order to significantly alter the electronic properties of the SWCNTs. This step is followed by a binder coating. The dispersion concentrations used in these methods make it very difficult to produce images via direct deposition (inkjet etc.) techniques. Further, such high solvent loads due to the low solids dispersions create long process times and difficulties handling the excess solvent. In addition, these patterning methods are subtractive processes, which unnecessarily waste the SWCNT material via additional removal steps thereby incurring cost and process time. This application also discloses method to make conductive compositions and coatings from such compositions but it does not teach satisfactory methods nor compositions to execute such methods.

As indicated above, the art discloses a wide variety of SWCNT dispersion schemes and compositions. However, there is still a critical need in the art for aqueous SWCNT compositions that are stable, with increased solid loadings using minimal dispersants in order to facilitate high speed, high volume coating techniques such as ink jet printing, roll coating, and offset printing while retaining high conductivity and transparency.

It is toward the objective of providing such improved electronically conductive, patternable, preferably web coatable, functionalized SWCNTs and functionalized SWCNT compositions that more effectively meet the diverse commercial needs than those of the prior art that the present invention is directed.

### PROBLEM TO BE SOLVED

The problem to be solved by this invention is the low solid levels (less than 100 ppm) of SWCNTs typically found in aqueous dispersions in the prior art without SWCNT dispersants and, alternatively, the problem of having very high levels of dispersants in order to increase the solids level.

### SUMMARY OF THE INVENTION

It is an object of the present invention to provide a coating composition comprising an aqueous dispersion of single wall carbon nanotubes with covalently attached hydrophilic species selected from the group consisting of carboxylic acid, nitrates, hydroxyls, carbonyls, and phosphates, in an amount of at least 0.5 atomic % of said carbon nanotubes, wherein said carbon nanotubes are present in an amount of at least 0.05 wt. % of said dispersion.

It is an object of the present invention to provide coating compositions comprising functionalized single wall carbon nanotubes capable of producing aqueous coating compositions at solid loadings suitable for conventional coating techniques.

It is another object of the invention to provide coating compositions capable of producing highly conductive layers in single pass coating steps.

### ADVANTAGEOUS EFFECT OF THE INVENTION

The invention has numerous advantages. The invention provides novel SWCNT compositions, which provide a facile means to produce coating compositions.

The invention provides compositions with sufficient SWCNT solids loadings capable of producing coatings in single pass modes.

The invention provides a facile method to produce coating compositions that have stable, elevated levels of SWCNTs with minimal to no dispersant loadings.

These and other advantages will be apparent from the detailed description below.

### BRIEF DESCRIPTION OF THE DRAWINGS

FIG. 1 shows a pristine SWCNT with either open or closed ends.

FIG. 2 shows a covalently functionalized SWCNT with either open or closed ends.

FIG. 3 Shows a schematic of a display component formed by the methods of the invention comprising a receiver element having a conductive layer connected to a power source by an electric lead.

FIG. 4 Shows a schematic of an illustrative polymer dispersed LC display, as per the invention.

FIG. 5 Shows a schematic of an OLED based display, as per the invention.

FIG. 6. Shows a schematic of an illustrative resistive-type touch screen, as per the invention.

### DETAILED DESCRIPTION OF THE INVENTION

The method in accordance with the present invention involves the dispersion formation, coating and subsequent drying of a coating composition containing functionalized SWCNTs. The type and, more particularly, level of functionalization allow the ability to create stable, elevated loadings of SWCNTs that permit easy deposition and film formation suitable to produce high conductivity and high transparency coatings.

The SWCNTs may be formed by any known methods in the art (laser ablation, CVD, arc discharge). The SWCNTs are preferred to have minimal or no impurities of metals that may be used in such synthetic methods and carbonaceous impurities that are not single wall carbon nanotubes (graphite, amorphous, diamond, non-tubular fullerenes, multiwall carbon nanotubes). It is found that the transparency increases significantly with the decrease of metallic and carbonaceous impurities. The film quality as evidenced by layer uniformity, surface roughness, and a reduction in particulates also improves with a decrease in the amount of metallic and carbonaceous impurities.

To achieve high electronic conductivity, metallic SWCNTs are the most preferred type but semimetallic and semiconducting may also be used. A pristine SWCNT means that the surface of the SWCNT is free of covalently functionalized materials either through synthetic prep, acid cleanup of impurities, annealing or directed functionalization. Functionalization is a preferred embodiment of this invention; preferably the functional group is a hydrophilic species selected from carboxylic acid, carboxylate anion (carboxylic acid salt), hydroxyl, sulfur containing groups, carbonyl, phosphates, nitrates or combinations of these hydrophilic species. Sulfur containing groups may contain sulfenic acid, sulfinic acid and/or sulfonic acid and/or the corresponding anions or mixtures thereof. In some applications other types of functionalization such as polymer, small molecule or combinations thereof may be required. For example, such functionalization may improve the compatibility of the SWCNT in a particular polymer matrix. However, such functionalization schemes do not provide the high solid loadings coating compositions that are necessary to produce high conductivity and high transparency films.

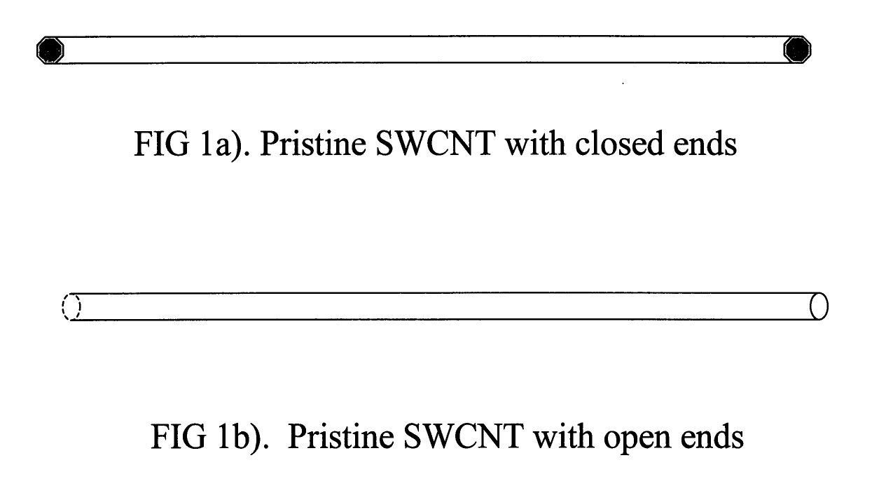

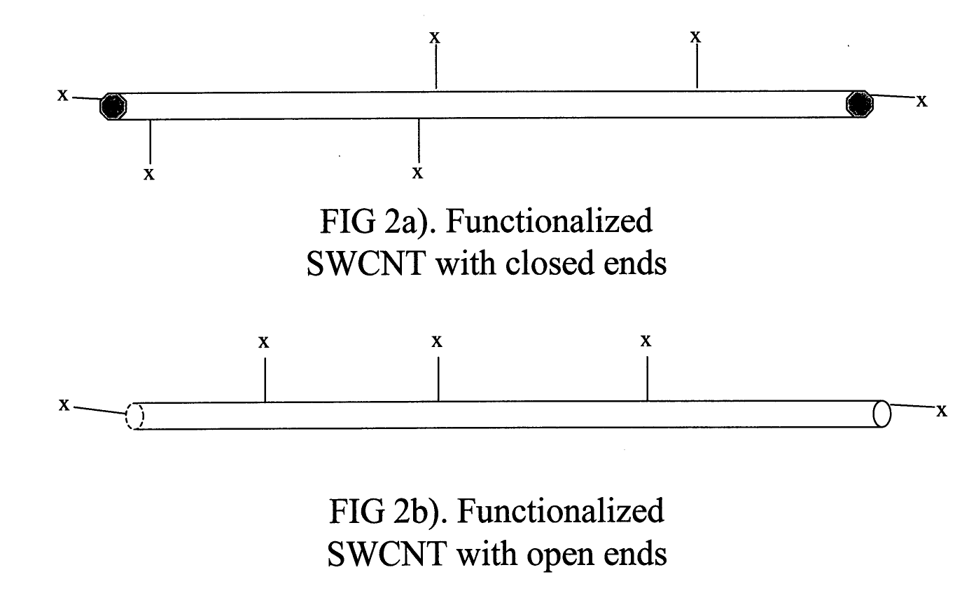

Turning to FIG. 1, pristine SWCNTs with either open or closed ends are illustrated. SWCNTs that are pristine are essentially intractable in most solvents, especially aqueous, without the use of high levels of dispersants. Therefore, it is not possible to use only pristine SWCNTs and water to produce an aqueous coating composition. FIG. 2 exemplifies the basic structure of covalently functionalized SWCNTs. The X in FIG. 2 may be selected from one of the hydrophilic species listed above. It is worth noting that the X may be positioned at any point on the SWCNT, external or internal surface, open or closed end, or sidewall. It is preferred that the X be uniformly distributed across the external surface, potentially for the most effectiveness.

The most preferred covalent surface functionalization is carboxylic acid or a carboxylic acid salt or mixtures thereof (hereafter referred to as only carboxylic acid). For carboxylic acid based functionalization, the preferred level of functionalized carbons on the SWCNT is 0.5-100 atomic percent, where 1 atomic percent functionalized carbons would be 1 out of every 100 carbons in the SWCNT have a functional group covalently attached. The functionalized carbons may exist anywhere on the nanotubes (open or closed ends, external and internal sidewalls). As already mentioned, preferably the functionalization is on the external surface of the SWCNTs. More preferably the functionalized percent range is 0.5-50 atomic percent, and most preferably 0.5-20 atomic percent. Functionalization of the SWCNTs with these groups within these atomic percent ranges allows the preparation of stable dispersions at the solids loadings necessary to form highly conductive, transparent films by conventional coating means. This coating composition allows for very effective dispersion in substantially aqueous dispersions and does not require a dispersion aid. Transparency is defined as a layer that has greater than 60% bulk transmission of light in the visible wavelength regime. The functionalization may be carried out by a number of routes. Typically, the raw material (unfunctionalized) SWCNTs are added to a bath of strongly oxidizing agents (hydrochloric acid, hydrofluoric acid, hydrobromic acid, hydroiodic acid, sulfuric acid, oleum, nitric acid, citric acid, oxalic acid, chlorosulfonic acid, phosphoric acid, trifluoromethane sulfonic acid, glacial acetic acid, monobasic organic acids, dibasic organic acids, potassium permanganate, persulfate, cerate, bromate, hydrogen peroxide, dichromate) which may be mixtures. Temperatures from 20° C.-120° C. are typically used in reflux of this mixture of SWCNTs and strong oxidizing agents with appropriate agitation over 1 hr—several days process time. At the end of this process, the raw SWCNTs are now functionalized SWCNTs. The residual oxidizing agents are removed via separation technologies (filtration wash, centrifugation, cross-flow filtration) such that a powder of the functionalized SWCNTs (primarily carboxylic acid functionalities) remains after appropriate heating to dry.

The pH of the dispersion and the coating composition is important. As the pH becomes more basic (above the pKa of the carboxylic acid groups), the carboxylic acid will be ionized thereby making the carboxylate anion, a bulky, repulsive group which can aid in the stability. Preferred pH ranges from 3-10 pH. More preferred pH ranges from 3-6.

The length of the SWCNTs may be from 20 nm-1 m. The SWCNTs may exist as individual SWCNTs or as bundles of SWCNTs. The diameter of a SWCNT in the conductive layer may be 0.5 nm-5 nm. The SWCNTs in bundled form may have diameters ranging from 1 nm-1 um. Preferably such bundles will have diameters less than 50 nm and preferably less than 20 nm. It is important that higher surface area is achieved to facilitate transfer of electrons and higher available surface area is achieved by having smaller bundle sizes thereby exposing surfaces of SWCNTs which may be at the internal position of the bundles and not accessible. The ends of the SWCNTs may be closed by a hemispherical buckyball of appropriate size. Alternatively, both of the ends of the SWCNTs may be open. Some cases may find one end open and the other end closed.

The functionalized SWCNTs (produced as described above or purchased from a vendor) are used to form aqueous dispersions with solids loadings in the 500-5000 ppm range. The functionalized SWCNTs are often in powder/flake form and require energy to disperse. A typical dispersion process may use a high shear mixing apparatus (homogenizer, microfluidizer, cowles blade high shear mixer, automated media mill, ball mill) for several minutes to an hour. We have also found that standard ultrasonication and bath sonication may be sufficient to disperse the functionalized SWCNTs. Typically, a 1000 ppm SWCNT dispersion in deionized water is formed by bath sonication for 2-24 hrs (dependant on the level of hydrophilic functionalization). After the dispersion process, pH can be adjusted to desired range. A centrifugation or filtration process is used to remove large particulates. The resultant dispersion will be stable for several months on standing (dependant on the level of hydrophilic functionalization). This dispersion has solids loadings high enough to produce conductive coatings in single pass modes for many coating techniques.

The conductive layer of the invention should contain about 0.1 to about 1000 mg/m² dry coating weight of the functionalized SWCNT. Preferably, the conductive layer should contain about 0.5 to about 500 mg/m² dry coating weight of the functionalized SWCNT. The actual dry coating weight of the SWCNTs applied is determined by the properties for the particular conductive functionalized SWCNT employed and by the requirements for the particular application, the requirements may include, for example, the conductivity, transparency, optical density, cost, etc for the layer.

The conductive layer may be employed for either electronic or thermal conduction or both. It is preferred that the conductive layer have electronic conductivity ranging from 100-10,000 Siemens/cm over a range of temperatures. This electrically conductive layer may be a continuous layer or patterned according to a predetermined structure.

In a preferred embodiment the conductive layer will have a thermal conductivity ranging from 100-50,000 W/m-K over a range of temperatures. This thermally conductive layer may be a continuous or patterned layer according to a predetermined structure.

In a preferred embodiment, the layer containing the conductive SWCNTs is prepared by applying a mixture containing:

a) a SWCNT according to Formula I; 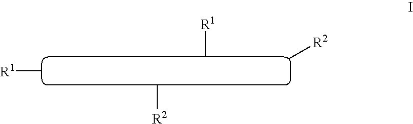
wherein each of R¹ and R² independently represents carboxylic acid, carboxylate anion (carboxylic acid salt), hydroxyl, sulfur containing groups, carbonyl, phosphates, nitrates, and the tube is a single wall carbon nanotube composed of carbon atoms substantially in hexagonal configuration, and, optionally

b) a dispersant and, optionally

b) a polymeric binder.

The R¹ and R² substituents may be uniformly or non-uniformly distributed across the SWCNT. The dispersant loading in the dispersion is preferred to be minimal to none. The maximum dispersant loading is preferred to be 20 wt % of the weight of the SWCNT. Typically the dispersant loading is less than 10 wt % of the weight of the SWCNT. The most preferred dispersant loading is less than 1 wt % of the weight of the SWCNT. There are many dispersants which may be chosen. Preferred dispersants are TX-100, sodium dodecyl sulfate, sodium dodecylbenzenesulfonate, poly(styrene sulfonate), sodium salt, poly(vinylpyrrolidone), Pluronics, Brij 78, Brij 700, and cetyl or dodecyltrimethylammonium bromide. Appropriate mixtures of these dispersants may be utilized.

Additionally, a preferred embodiment for functionalization of this invention can preferably be where the hydrophilic species is a sulfur containing group selected from:
SOₓZ_{y}
x may range from 1-3 and Z may be a Hydrogen atom or a metal cation such metals as Na, Mg, K, Ca, Zn, Mn, Ag, Au, Pd, Pt, Fe, Co and y may range from 0 or 1. The sulfur containing groups listed above may be sulfenic acid, sulfinic acid and/or sulfonic acid and/or the corresponding anions or mixtures thereof. The most preferred sulfur containing group for covalent surface functionalization is sulfonic acid or a sulfonic acid salt or mixtures thereof.

For environmental reasons, substantially aqueous systems (meaning at least 60 wt % water in the dispersion) are preferred. While the SWCNTs can be applied without the addition of a polymeric binder, preferably, a binder is employed to improve adhesion, film formation, smoothing, the physical properties of the layer and/or to improve the absorption of the coating composition. In such a preferred embodiment, the conductive layer may comprise from about 0.05 to 98% of the polymeric binder. The optimum weight percent of polymeric binder varies depending on the electrical properties of the functionalized SWCNTs, the chemical composition of the polymeric binder, and the requirements for the particular application.

Polymeric binders useful in the conductive layer of this invention can include, but are not limited to, water-soluble or water-dispersible hydrophilic polymers such as gelatin, gelatin derivatives, maleic acid or maleic anhydride copolymers, cellulose derivatives (such as carboxymethyl cellulose, hydroxyethyl cellulose, cellulose acetate butyrate, diacetyl cellulose, and triacetyl cellulose), polyvinyl alcohol, and poly-N-vinylpyrrolidone. Other suitable binders include aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins and aqueous dispersions of polyurethanes or polyesterionomers. Additionally, latex systems may be used as the binder. The latex particle size may range from 10 nm-100 um, depending on the application.

When employing aqueous coating compositions for the purpose of the present invention it is advantageous to utilize hydrophilic film-forming polymeric binders such as gelatin, gelatin derivatives, cellulose derivatives, or polyvinyl alcohol.

Other ingredients that may be included in the layer or coating composition containing the functionalized SWCNT include but are not limited to antiblocking agents, surfactants or coating aids, thickeners or rheology modifiers, hardeners or crosslinking agents, biocides, humectants and antidrying agents, stabilizers, pigments or dyes, lubricating agents, wetting aids, and various other conventional coating additives readily apparent to one skilled in the art. Dyes and pigments may be used in the printing solution when it is desirable to provide a visual record of the printed electrode pattern.

After depositing the film in continuous or patterned form the layer may be dried at temperatures ranging from room temperature to about 250° C.

The layer containing the SWCNT may be applied onto a variety of substrates depending on the intended use. The conductive layer of the invention can be formed on any rigid or flexible substrate. Rigid substrates can include glass, metal, ceramic and/or semiconductors. Suitable substrates include; glass, polymeric films such as polyester, polycarbonate, polystyrene, cellulose esters, polyolefins, and other well known polymer films, paper, silicon wafers, glass reinforced epoxy, etc. The conductive layer may be applied using any suitable coating method such as spin coating, hopper coating, roller coating, air knife coating, etc.

The substrates can be transparent, reflective, translucent or opaque, and may be colored or colorless. Flexible substrates, especially those comprising a plastic substrate, are preferred for their versatility and ease of manufacturing, coating and finishing.

The flexible plastic substrate can be any flexible self-substrateing plastic film that substrates the conductive polymeric film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self-supporting, yet should not be so thick as to be rigid. Another significant characteristic of the flexible plastic substrate material is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 200° C., some up to 300°-350° C., without damage.

Typically, the flexible plastic substrate is a polyester including polyethylene terephthalate (PET), polyethylene naphthalate (PEN), polyester ionomer, polyethersulfone (PES), polycarbonate (PC), polysulfone, a phenolic resin, an epoxy resin, polyester, polyimide, polyetherester, polyetheramide, cellulose nitrate, cellulose acetate, poly(vinyl acetate), polystyrene, polyolefins including polyolefin ionomers, polyamide, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA) natural and synthetic paper, resin-coated or laminated paper, voided polymers including polymeric foam, microvoided polymers and microporous materials, or fabric, or any combinations thereof.

Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although the substrate can be transparent, translucent or opaque, for most display applications transparent members comprising transparent substrate(s) are preferred. Although various examples of plastic substrates are set forth above, it should be appreciated that the flexible substrate can also be formed from other materials such as flexible glass and ceramic.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

The most preferred flexible plastic substrate is a polyester because of its superior mechanical and thermal properties as well as its availability in large quantity at a moderate price. The particular polyester chosen for use can be a homo-polyester or a co-polyester, or mixtures thereof as desired. The polyester can be crystalline or amorphous or mixtures thereof as desired. Polyesters are normally prepared by the condensation of an organic dicarboxylic acid and an organic diol and, therefore, illustrative examples of useful polyesters will be described herein below in terms of these diol and dicarboxylic acid precursors.

Polyesters which are suitable for use in this invention are those which are derived from the condensation of aromatic, cycloaliphatic, and aliphatic diols with aliphatic, aromatic and cycloaliphatic dicarboxylic acids and may be cycloaliphatic, aliphatic or aromatic polyesters. Exemplary of useful cycloaliphatic, aliphatic and aromatic polyesters which can be utilized in the practice of their invention are poly(ethylene terephthalate), poly(cyclohexlenedimethylene), terephthalate) poly(ethylene dodecate), poly(butylene terephthalate), poly(ethylene naphthalate), poly(ethylene(2,7-naphthalate)), poly(methaphenylene isophthalate), poly(glycolic acid), poly(ethylene succinate), poly(ethylene adipate), poly(ethylene sebacate), poly(decamethylene azelate), poly(ethylene sebacate), poly(decamethylene adipate), poly(decamethylene sebacate), poly(dimethylpropiolactone), poly(parahydroxybenzoate) (Ekonol), poly(ethylene oxybenzoate) (A-tell), poly(ethylene isophthalate), poly(tetramethylene terephthalate, poly(hexamethylene terephthalate), poly(decamethylene terephthalate), poly(1,4-cyclohexane dimethylene terephthalate) (trans), poly(ethylene 1,5-naphthalate), poly(ethylene 2,6-naphthalate), poly(1,4-cyclohexylene dimethylene terephthalate), (Kodel) (cis), and poly(1,4-cyclohexylene dimethylene terephthalate (Kodel) (trans). Polyester compounds prepared from the condensation of a diol and an aromatic dicarboxylic acid is preferred for use in this invention. Illustrative of such useful aromatic carboxylic acids are terephthalic acid, isophthalic acid and an α-phthalic acid, 1,3-napthalenedicarboxylic acid, 1,4 napthalenedicarboxylic acid, 2,6-napthalenedicarboxylic acid, 2,7-napthalenedicarboxylic acid, 4,4′-diphenyldicarboxylic acid, 4,4′-diphenysulfphone-dicarboxylic acid, 1,1,3-trimethyl-5-carboxy-3-(p-carboxyphenyl)-idane, diphenyl ether 4,4′-dicarboxylic acid, bis-p(carboxy-phenyl) methane, and the like. Of the aforementioned aromatic dicarboxylic acids, those based on a benzene ring (such as terephthalic acid, isophthalic acid, orthophthalic acid) are preferred for use in the practice of this invention. Amongst these preferred acid precursors, terephthalic acid is particularly preferred acid precursor.

Preferred polyesters for use in the practice of this invention include poly(ethylene terephthalate), poly(butylene terephthalate), poly(1,4-cyclohexylene dimethylene terephthalate) and poly(ethylene naphthalate) and copolymers and/or mixtures thereof. Among these polyesters of choice, poly(ethylene terephthalate) is most preferred.

The aforesaid substrate useful for application in display devices can be planar and/or curved. The curvature of the substrate can be characterized by a radius of curvature, which may have any value. Alternatively, the substrate may be bent so as to form an angle. This angle may be any angle from 0° to 360°, including all angles therebetween and all ranges therebetween. If the substrate is electrically conducting, an insulating material such as a non-conductive polymer may be placed between the substrate and the conducting polymer.

The substrate may be of any thickness, such as, for example. 10⁻⁸ cm to 1 cm including all values in between and all ranges therebetween. Thicker and thinner layers may be used. The substrate need not have a uniform thickness. The preferred shape is square or rectangular, although any shape may be used. Before the substrate is coated with the conducting polymer it may be physically and/or optically patterned, for example by rubbing, by the application of an image, by the application of patterned electrical contact areas, by the presence of one or more colors in distinct regions, by embossing, microembossing, microreplication, etc.

The aforesaid substrate can comprise a single layer or multiple layers according to need. The multiplicity of layers may include any number of auxiliary layers such as antistatic layers, tie layers or adhesion promoting layers, abrasion resistant layers, curl control layers, conveyance layers, barrier layers, splice providing layers, UV absorption layers, optical effect providing layers, such as antireflective and antiglare layers, waterproofing layers, adhesive layers, imaging layers and the like.

The polymer substrate can be formed by any method known in the art such as those involving extrusion, coextrusion, quenching, orientation, heat setting, lamination, coating and solvent casting. It is preferred that the polymer substrate is an oriented sheet formed by any suitable method known in the art, such as by a flat sheet process or a bubble or tubular process. The flat sheet process involves extruding or coextruding the materials of the sheet through a slit die and rapidly quenching the extruded or coextruded web upon a chilled casting drum so that the polymeric component(s) of the sheet are quenched below their solidification temperature.

The quenched sheet is then biaxially oriented by stretching in mutually perpendicular directions at a temperature above the glass transition temperature of the polymer(s). The sheet may be stretched in one direction and then in a second direction or may be simultaneously stretched in both directions. The preferred stretch ratio in any direction is at least 3:1. After the sheet has been stretched, it is heat set by heating to a temperature sufficient to crystallize the polymers while restraining to some degree the sheet against retraction in both directions of stretching.

The polymer sheet may be subjected to any number of coatings and treatments, after extrusion, coextrusion, orientation, etc. or between casting and full orientation, to improve its properties, such as printability, barrier properties, heat-sealability, spliceability, adhesion to other substrates and/or imaging layers. Examples of such coatings can be acrylic coatings for printability, polyvinylidene halide for heat seal properties, etc. Examples of such treatments can be flame, plasma and corona discharge treatment, ultraviolet radiation treatment, ozone treatment and electron beam treatment to improve coatability and adhesion. Further examples of treatments can be calendaring, embossing and patterning to obtain specific effects on the surface of the web. The polymer sheet can be further incorporated in any other suitable substrate by lamination, adhesion, cold or heat sealing, extrusion coating, or any other method known in the art.

In one embodiment, the aforementioned substrate and the aforementioned SWCNT conductive layer is incorporated as a transparent layer in a display device. The display device typically comprises at least one imageable layer wherein the imageable layer can contain an electrically imageable material. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. Light modulating materials can be electrochemical, electrophoretic, such as Gyricon particles, electrochromic, or liquid crystals. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple substrate layers, however, are optional for providing additional advantages in some case.

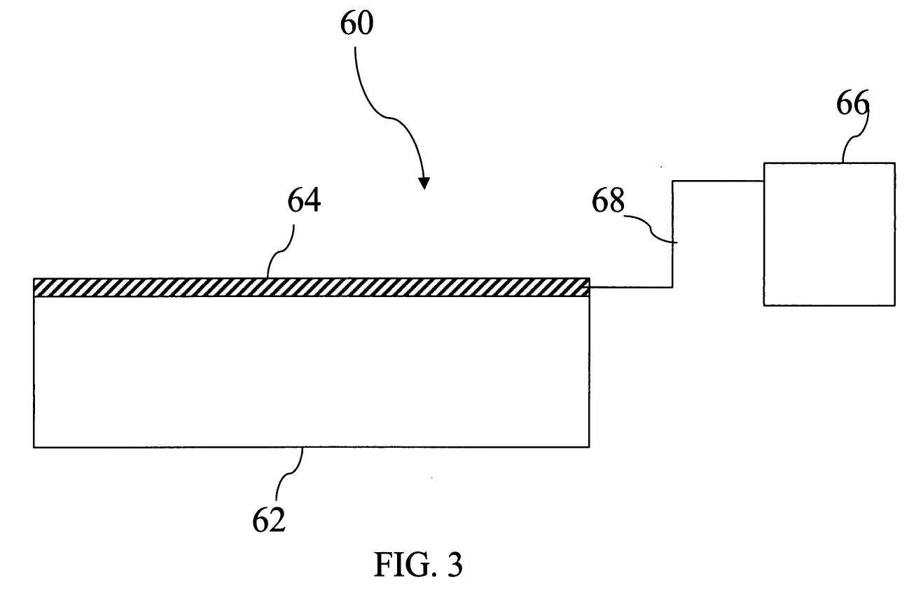

The present invention, comprising the aforementioned SWCNT conductive layer may simply be substituted for any one or more conducting electrodes present in such prior art devices. The present invention preferably has at least one electric lead attached to (in contact with) the electronically conductive polymer layer on the substrate for the application of current, voltage, etc. to said conductive polymer (i.e. electrically connected). The lead(s) is/are preferably not in electrical contact with the substrate and may be made of patterned deposited metal, conductive or semiconductive material, such as ITO, may be a simple wire in contact with the SWCNT, and/or conductive paint comprising, for example, a conductive polymer, carbon, SWCNT, and/or metal particles. Devices according to the invention preferably also include a current or a voltage source electrically connected to the conducting electrode through the lead(s). A power source, battery, etc. may be used. One embodiment of the invention is illustrated in FIG. 3 as a display component 60, wherein a substrate 62 is coated with a SWCNT conductive layer 64, which is connected to a power source 66 by means of an electric lead 68.

In a preferred embodiment, the electrically imageable material can be addressed with an electric field and then retain its image after the electric field is removed, a property typically referred to as “bistable”. Particularly suitable electrically imageable materials that exhibit “bistability” are electrochemical, electrophoretic, such as Gyricon particles, electrochromic, magnetic, or chiral nematic liquid crystals. Especially preferred are chiral nematic liquid crystals. The chiral nematic liquid crystals can be polymer dispersed liquid crystals (PDLC).

For purpose of illustration of the application of the present invention, the display will be described primarily as a liquid crystal display. However, it is envisioned that the present invention may find utility in a number of other display applications.

Display

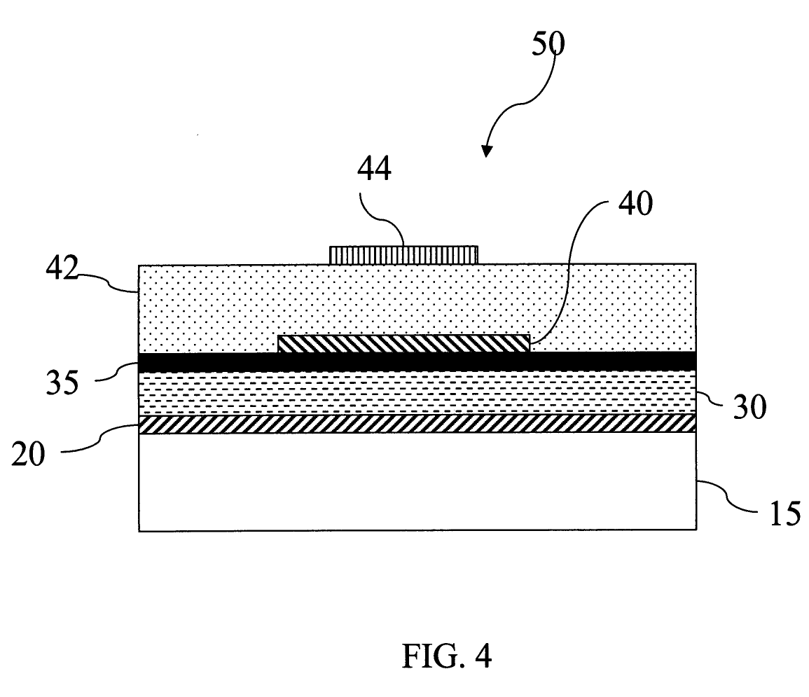

As used herein, a “liquid crystal display” (LCD) is a type of flat panel display used in various electronic devices. At a minimum, an LCD comprises a substrate, at least one conductive layer and a liquid crystal layer. LCDs may also comprise two sheets of polarizing material with a liquid crystal solution between the polarizing sheets. The sheets of polarizing material may comprise a substrate of glass or transparent plastic. The LCD may also include functional layers. In one embodiment of an LCD item 50, illustrated in FIG. 4, a transparent, multilayer flexible substrate 15 is coated with a first conductive layer 20, which may be patterned, onto which is coated the light-modulating liquid crystal layer 30. A second conductive layer 40 is applied and overcoated with a dielectric layer 42 to which dielectric conductive row contacts 44 are attached, including vias (not shown) that permit interconnection between conductive layers and the dielectric conductive row contacts. FIG. 4 shows an optional nanopigmented functional layer 35 applied between the liquid crystal layer 30 and the second conductive layer 40. In a typical matrix-address light-emitting display device, numerous light-emitting devices are formed on a single substrate and arranged in groups in a regular grid pattern. Activation may be by rows and columns.

The liquid crystal (LC) is used as an optical switch. The substrates are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

Chiral nematic liquid crystal refers to the type of liquid crystal having finer pitch than that of twisted nematic and super-twisted nematic used in commonly encountered LC devices. Chiral nematic liquid crystals are so named because such liquid crystal formulations are commonly obtained by adding chiral agents to host nematic liquid crystals. Chiral nematic liquid crystals may be used to produce bi-stable or multi-stable displays. These devices have significantly reduced power consumption due to their non-volatile “memory” characteristic. Since such displays do not require a continuous driving circuit to maintain an image, they consume significantly reduced power. Chiral nematic displays are bistable in the absence of a field; the two stable textures are the reflective planar texture and the weakly scattering focal conic texture. In the planar texture, the helical axes of the chiral nematic liquid crystal molecules are substantially perpendicular to the substrate upon which the liquid crystal is disposed. In the focal conic state the helical axes of the liquid crystal molecules are generally randomly oriented. Adjusting the concentration of chiral dopants in the chiral nematic material modulates the pitch length of the mesophase and, thus, the wavelength of radiation reflected. Chiral nematic materials that reflect infrared radiation and ultraviolet have been used for purposes of scientific study. Commercial displays are most often fabricated from chiral nematic materials that reflect visible light. Some known LCD devices include chemically-etched, transparent, conductive layers overlying a glass substrate as described in U.S. Pat. No. 5,667,853.

In one embodiment, a chiral-nematic liquid crystal composition may be dispersed in a continuous matrix. Such materials are referred to as “polymer-dispersed liquid crystal” materials or “PDLC” materials. Such materials can be made by a variety of methods. For example, Doane et al. (Applied Physics Letters, 48, 269 (1986)) disclose a PDLC comprising approximately 0.4 μg/m droplets of nematic liquid crystal 5CB in a polymer binder. A phase separation method is used for preparing the PDLC. A solution containing monomer and liquid crystal is filled in a display cell and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid-crystal material and polymer (a hydroxy functionalized polymethylmethacrylate) along with a cross-linker for the polymer are dissolved in a common organic solvent toluene and coated on a transparent conductive layer on a substrate. A dispersion of the liquid-crystal material in the polymer binder is formed upon evaporation of toluene at high temperature. The phase separation methods of Doane et al. and West et al. require the use of organic solvents that may be objectionable in certain manufacturing environments.

The contrast of the display is degraded if there is more than a substantial monolayer of N*LC domains. The term “substantial monolayer” is defined by the Applicants to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

In a preferred embodiment of the invention, the display device or display sheet has simply a single imaging layer of liquid crystal material along a line perpendicular to the face of the display, preferably a single layer coated on a flexible substrate. Such as structure, as compared to vertically stacked imaging layers each between opposing substrates, is especially advantageous for monochrome shelf labels and the like. Structures having stacked imaging layers, however, are optional for providing additional advantages in some case.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material can be defined as having a major axis and a minor axis. In a preferred embodiment of a display or display sheet, the major axis is larger in size than the cell (or imaging layer) thickness for a majority of the domains. Such a dimensional relationship is shown n U.S. Pat. No. 6,061,107.

Modern chiral nematic liquid crystal materials usually include at least one nematic host combined with a chiral dopant. In general, the nematic liquid crystal phase is composed of one or more mesogenic components combined to provide useful composite properties. Many such materials are available commercially. The nematic component of the chiral nematic liquid crystal mixture may be comprised of any suitable nematic liquid crystal mixture or composition having appropriate liquid crystal characteristics. Nematic liquid crystals suitable for use in the present invention are preferably composed of compounds of low molecular weight selected from nematic or nematogenic substances, for example from the known classes of the azoxybenzenes, benzylideneanilines, biphenyls, terphenyls, phenyl or cyclohexyl benzoates, phenyl or cyclohexyl esters of cyclohexanecarboxylic acid; phenyl or cyclohexyl esters of cyclohexylbenzoic acid; phenyl or cyclohexyl esters of cyclohexylcyclohexanecarboxylic acid; cyclohexylphenyl esters of benzoic acid, of cyclohexanecarboxyiic acid and of cyclohexylcyclohexanecarboxylic acid; phenyl cyclohexanes; cyclohexylbiphenyls; phenyl cyclohexylcyclohexanes; cyclohexylcyclohexanes; cyclohexylcyclohexenes; cyclohexylcyclohexylcyclohexenes; 1,4-bis-cyclohexylbenzenes; 4,4-bis-cyclohexylbiphenyls; phenyl- or cyclohexylpyrimidines; phenyl- or cyclohexylpyridines; phenyl- or cyclohexylpyridazines; phenyl- or cyclohexyldioxanes; phenyl- or cyclohexyl-1,3-dithianes; 1,2-diphenylethanes; 1,2-dicyclohexylethanes; 1-phenyl-2-cyclohexylethanes; 1-cyclohexyl-2-(4-phenylcyclohexyl)ethanes; 1-cyclohexyl-2′,2-biphenylethanes; 1-phenyl-2-cyclohexylphenylethanes; optionally halogenated stilbenes; benzyl phenyl ethers; tolanes; substituted cinnamic acids and esters; and further classes of nematic or nematogenic substances. The 1,4-phenylene groups in these compounds may also be laterally mono- or difluorinated. The liquid crystalline material of this preferred embodiment is based on the achiral compounds of this type. The most important compounds, that are possible as components of these liquid crystalline materials, can be characterized by the following formula R′—X—Y-Z-R″ wherein X and Z, which may be identical or different, are in each case, independently from one another, a bivalent radical from the group formed by -Phe-, -Cyc-, -Phe-Phe-, -Phe-Cyc-, -Cyc-Cyc-, -Pyr-, -Dio-, —B-Phe- and —B-Cyc-; wherein Phe is unsubstituted or fluorine-substituted 1,4-phenylene, Cyc is trans-1,4-cyclohexylene or 1,4-cyclohexenylene, Pyr is pyrimidine-2,5-diyl or pyridine-2,5-diyl, Dio is 1,3-dioxane-2,5-diyl, and B is 2-(trans-1,4-cyclohexyl)ethyl, pyrimidine-2,5-diyl, pyridine-2,5-diyl or 1,3-dioxane-2,5-diyl. Y in these compounds is selected from the following bivalent groups —CH═CH—, —C≡C—, —N═N(O)—, —CH═CY′—, —CH═N(O)—, —CH2—CH2—, —CO—O—, —CH2-O—, —CO—S—, —CH2-S—, —COO-Phe-COO— or a single bond, with Y′ being halogen, preferably chlorine, or —CN; R′ and R″ are, in each case, independently of one another, alkyl, alkenyl, alkoxy, alkenyloxy, alkanoyloxy, alkoxycarbonyl or alkoxycarbonyloxy with 1 to 18, preferably 1 to 12 C atoms, or alternatively one of R′ and R″ is —F, —CF3, —OCF3, —Cl, —NCS or —CN. In most of these compounds R′ and R′ are, in each case, independently of each another, alkyl, alkenyl or alkoxy with different chain length, wherein the sum of C atoms in nematic media generally is between 2 and 9, preferably between 2 and 7. The nematic liquid crystal phases typically consist of 2 to 20, preferably 2 to 15 components. The above list of materials is not intended to be exhaustive or limiting. The lists disclose a variety of representative materials suitable for use or mixtures, which comprise the active element in electro-optic liquid crystal compositions.

Suitable chiral nematic liquid crystal compositions preferably have a positive dielectric anisotropy and include chiral material in an amount effective to form focal conic and twisted planar textures. Chiral nematic liquid crystal materials are preferred because of their excellent reflective characteristics, bi-stability and gray scale memory. The chiral nematic liquid crystal is typically a mixture of nematic liquid crystal and chiral material in an amount sufficient to produce the desired pitch length. Suitable commercial nematic liquid crystals include, for example, E7, E44, E48, E31, E80, BL087, BL101, ZLI-3308, ZLI-3273, ZLI-5048-000, ZLI-5049-100, ZLI-5100-100, ZLI-5800-000, MLC-6041-100.TL202, TL203, TL204 and TL205 manufactured by E. Merck (Darmstadt, Germany). Although nematic liquid crystals having positive dielectric anisotropy, and especially cyanobiphenyls, are preferred, virtually any nematic liquid crystal known in the art, including those having negative dielectric anisotropy should be suitable for use in the invention. Other nematic materials may also be suitable for use in the present invention as would be appreciated by those skilled in the art.

The chiral dopant added to the nematic mixture to induce the helical twisting of the mesophase, thereby allowing reflection of visible light, can be of any useful structural class. The choice of dopant depends upon several characteristics including among others its chemical compatibility with the nematic host, helical twisting power, temperature sensitivity, and light fastness. Many chiral dopant classes are known in the art: e.g., G. Gottarelli and G. Spada, Mol. Cryst. Liq. Crys., 123, 377 (1985); G. Spada and G. Proni, Enantiomer, 3, 301 (1998) and references therein. Typical well-known dopant classes include 1,1-binaphthol derivatives; isosorbide (D-1) and similar isomannide esters as disclosed in U.S. Pat. No. 6,217,792; TADDOL derivatives (D-2) as disclosed in U.S. Pat. No. 6,099,751; and the pending spiroindanes esters (D-3) as disclosed in U.S. patent application Ser. No. 10/651,692 by T. Welter et al., filed Aug. 29, 2003, titled “Chiral Compounds And Compositions Containing The Same.”

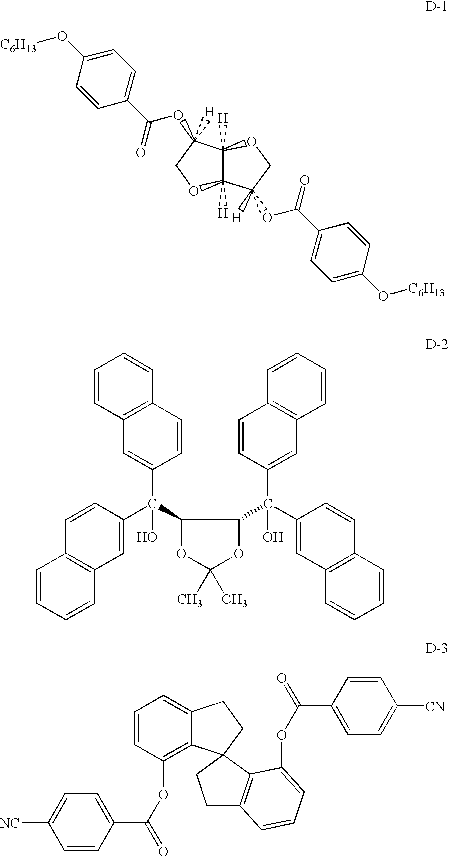

The pitch length of the liquid crystal materials may be adjusted based upon the following equation (1):
λmax=navp0
where λ max is the peak reflection wavelength, that is, the wavelength at which reflectance is a maximum, nav is the average index of refraction of the liquid crystal material, and p0 is the natural pitch length of the chiral nematic helix. Definitions of chiral nematic helix and pitch length and methods of its measurement, are known to those skilled in the art such as can be found in the book, Blinov, L. M., Electro-optical and Magneto-Optical Properties of Liquid Crystals, John Wiley & Sons Ltd. 1983. The pitch length is modified by adjusting the concentration of the chiral material in the liquid crystal material. For most concentrations of chiral dopants, the pitch length induced by the dopant is inversely proportional to the concentration of the dopant. The proportionality constant is given by the following equation (2):
p0=1/(HTP.c)

where c is the concentration of the chiral dopant and HTP (as termed □ in some references) is the proportionality constant.

For some applications, it is desired to have LC mixtures that exhibit a strong helical twist and thereby a short pitch length. For example in liquid crystalline mixtures that are used in selectively reflecting chiral nematic displays, the pitch has to be selected such that the maximum of the wavelength reflected by the chiral nematic helix is in the range of visible light. Other possible applications are polymer films with a chiral liquid crystalline phase for optical elements, such as chiral nematic broadband polarizers, filter arrays, or chiral liquid crystalline retardation films. Among these are active and passive optical elements or color filters and liquid crystal displays, for example STN, TN, AMD-TN, temperature compensation, polymer free or polymer stabilized chiral nematic texture (PFCT, PSCT) displays. Possible display industry applications include ultralight, flexible, and inexpensive displays for notebook and desktop computers, instrument panels, video game machines, videophones, mobile phones, hand-held PCs, PDAs, e-books, camcorders, satellite navigation systems, store and supermarket pricing systems, highway signs, informational displays, smart cards, toys, and other electronic devices.

There are alternative display technologies to LCDs that may be used, for example, in flat panel displays. A notable example is organic or polymer light emitting devices (OLEDs) or (PLEDs), which are comprised of several layers in which one of the layers is comprised of an organic material that can be made to electroluminesce by applying a voltage across the device. An OLED device is typically a laminate formed in a substrate such as glass or a plastic polymer. Alternatively, a plurality of these OLED devices may be assembled such to form a solid state lighting display device.

A light emitting layer of a luminescent organic solid, as well as adjacent semiconductor layers, are sandwiched between an anode and a cathode. The semiconductor layers may be hole injecting and electron injecting layers. PLEDs may be considered a subspecies of OLEDs in which the luminescent organic material is a polymer. The light emitting layers may be selected from any of a multitude of light emitting organic solids, e.g., polymers that are suitably fluorescent or chemiluminescent organic compounds. Such compounds and polymers include metal ion salts of 8-hydroxyquinolate, trivalent metal quinolate complexes, trivalent metal bridged quinolate complexes, Schiff-based divalent metal complexes, tin (IV) metal complexes, metal acetylacetonate complexes, metal bidenate ligand complexes incorporating organic ligands, such as 2-picolylketones, 2-quinaldylketones, or 2-(o-phenoxy) pyridine ketones, bisphosphonates, divalent metal maleonitriledithiolate complexes, molecular charge transfer complexes, rare earth mixed chelates, (5-hydroxy) quinoxaline metal complexes, aluminum tris-quinolates, and polymers such as poly(p-phenylenevinylene), poly(dialkoxyphenylenevinylene), poly(thiophene), poly(fluorene), poly(phenylene), poly(phenylacetylene), poly(aniline), poly(3-alkylthiophene), poly(3-octylthiophene), and poly(N-vinylcarbazole). When a potential difference is applied across the cathode and anode, electrons from the electron injecting layer and holes from the hole injecting layer are injected into the light emitting layer; they recombine, emitting light. OLEDs and PLEDs are described in the following United States patents, all of which are incorporated herein by this reference: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

In a typical matrix address light emitting display device, numerous light emitting devices are formed on a single substrate and arranged in groups in a regular grid pattern. Activation may be by rows and columns, or in an active matrix with individual cathode and anode paths. OLEDs are often manufactured by first depositing a transparent electrode on the substrate, and patterning the same into electrode portions. The organic layer(s) is then deposited over the transparent electrode. A metallic electrode may be formed over the organic layers. For example, in U.S. Pat. No. 5,703,436 to Forrest et al., incorporated herein by reference, transparent indium tin oxide (ITO) is used as the hole injecting electrode, and a Mg—Ag-ITO electrode layer is used for electron injection.

The present invention can be employed in most OLED device configurations as an electrode, preferably as an anode. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

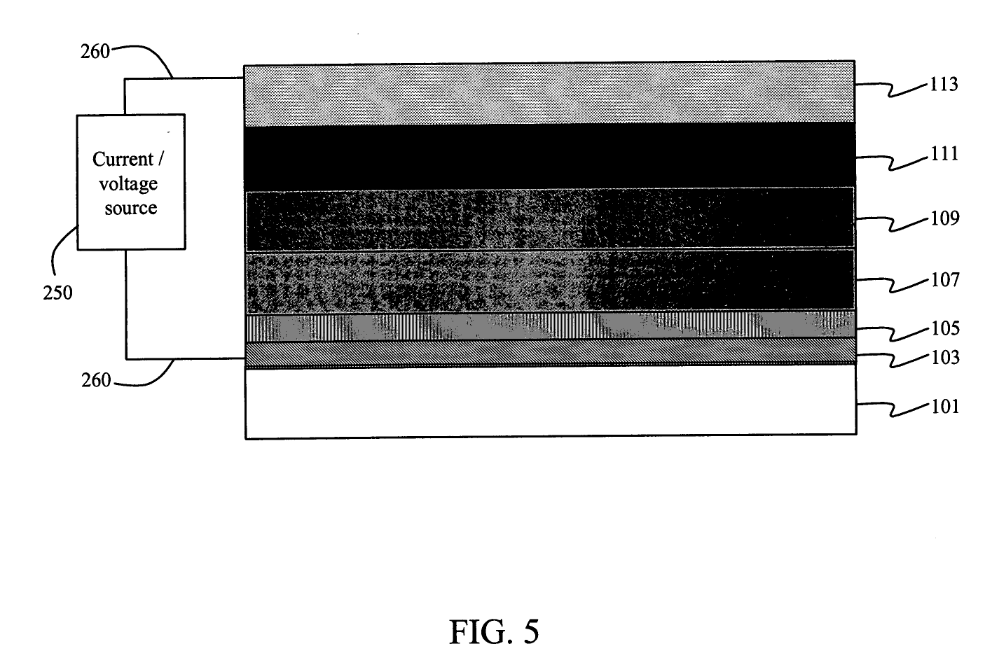

There are numerous configurations of the organic layers wherein the present invention can be successfully practiced. A typical structure is shown in FIG. 5 and is comprised of a substrate 101, an anode 103, a hole-injecting layer 105, a hole-transporting layer 107, a light-emitting layer 109, an electron-transporting layer 111, and a cathode 113. These layers are described in more detail below. Note that the substrate may alternatively be located adjacent to the cathode, or the substrate may actually constitute the anode or cathode. The organic layers between the anode and cathode are conveniently referred to as the organic electroluminescent (EL) element. The total combined thickness of the organic layers is preferably less than 500 nm.

The anode and cathode of the OLED are connected to a voltage/current source 250 through electrical conductors 260. The OLED is operated by applying a potential between the anode and cathode such that the anode is at a more positive potential than the cathode. Holes are injected into the organic EL element from the anode and electrons are injected into the organic EL element at the anode. Enhanced device stability can sometimes be achieved when the OLED is operated in an AC mode where, for some time period in the cycle, the potential bias is reversed and no current flows. An example of an AC driven OLED is described in U.S. Pat. No. 5,552,678.

When EL emission is viewed through anode 103, the anode should be transparent or substantially transparent to the emission of interest. Thus, the transparency of this invention is critical for such OLED display devices. Common transparent anode materials used in this invention are indium-fin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, the transmissive characteristics of anode are generally immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize shorts or enhance reflectivity. It is hoped that the conductive film will have acceptable surface roughness as a result of the film forming capabilities of the polymeric binder and ratio chosen.

Another application of the invention is envisioned for touch screens. Touch screens are widely used in conventional CRTs and in flat-panel display devices in computers and in particular with portable computers. The present invention can be applied as a transparent conductive member in any of the touch screens known in the art, including but not limited to those disclosed in U.S. Pat. Appl. Pub. 2003/0170456 A1; 2003/0170492 A1; U.S. Pat. No. 5,738,934; and WO 00/39835, and incorporated herein by reference.

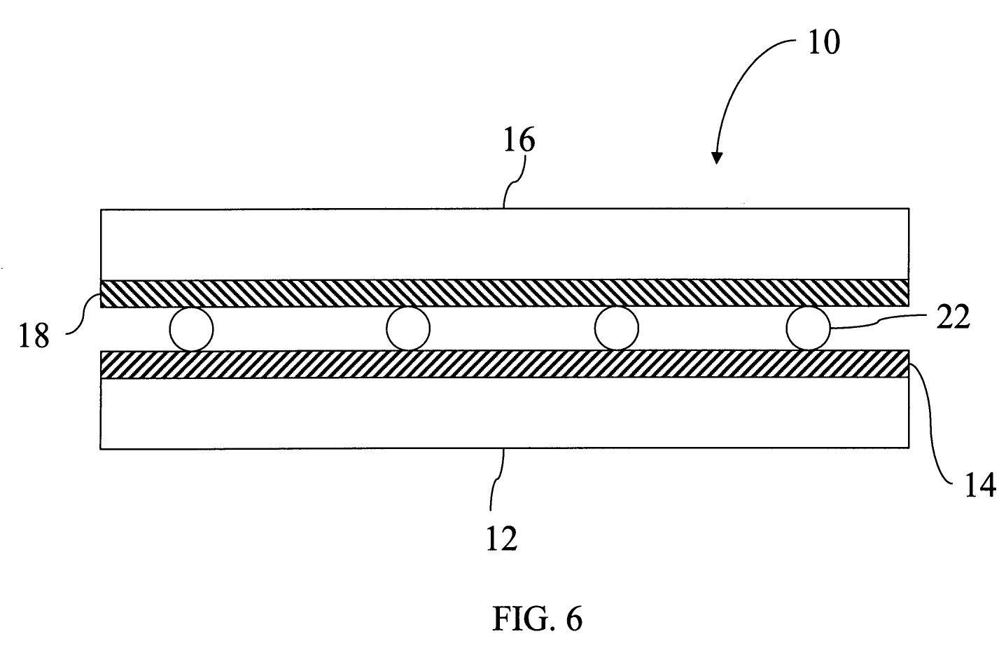

FIG. 6 shows a multilayered item 10 for a typical prior art resistive-type touch screen including a transparent substrate 12, having a first conductive layer 14. A flexible transparent cover sheet 16 includes a second conductive layer 18 that is physically separated from the first conductive layer 14 by spacer elements 20. A voltage is developed across the conductive layers. The conductive layers 14 and 18 have a resistance selected to optimize power usage and position sensing accuracy. Deformation of the flexible cover sheet 16 by an external object such as a finger or stylus causes the second conductive layer 18 to make electrical contact with first conductive layer 14, thereby transferring a voltage between the conductive layers. The magnitude of this voltage is measured through connectors (not shown) connected to metal conductive patterns (not shown) formed on the edges of conductive layers 18 and 14 to locate the position of the deforming object. The article of the inventions would be the conductive layers.

The conventional construction of a resistive touch screen involves the sequential placement of materials upon the substrate. The substrate 12 and cover sheet 16 are first cleaned, then uniform conductive layers are applied to the substrate and cover sheet. It is known to use a coatable electronically conductive polymer such as polythiophene or polyaniline to provide the flexible conductive layers. See for example WO 00/39835, which shows a light transmissive substrate having a light transmissive conductive polymer coating, and U.S. Pat. No. 5,738,934 which shows a cover sheet having a conductive polymer coating. The spacer elements 20 are then applied and, finally, the flexible cover sheet 16 is attached.

The invention is further described by the following non-limiting examples.

Ingredients for Coating Compositions (Dispersions)

(a) TX-100: nonionic surfactant supplied by Rohm & Haas

(b) P3 SWCNT: single wall carbon nanotubes with covalently attached carboxylic acids (atomic % described below) supplied by Carbon Solutions Inc.

(c) P2 SWCNT: single wall carbon nanotubes with covalently attached carboxylic acids (atomic % described below) supplied by Carbon Solutions Inc.

(d) RFP SWCNT: single wall carbon nanotubes with covalently attached carboxylic acids (atomic % described below) supplied by Carbon Solutions Inc.

(e) HiPCO SWCNT: single wall carbon nanotubes with covalently attached carboxylic acids (atomic % described below) supplied by Carbon Nanotechnologies Inc.

The atomic % of carboxylic acids on each type of SWCNT has been determined by titration methods as described below. Table 1 indicates the level of carboxylic acids we determined for each SWCNT.

TABLE 1

| | | % of C atoms |
|---|---|---|
| | | functionalized by |
| SWCNT Type | Vendor | COOH (atomic %) |
| P2 | Carbon Solutions Inc. | 0.46 |
| P3 | Carbon Solutions Inc. | 2.74 |
| HiPCO | Carbon Nanotechnologies Inc. | 0.11 |
| RFP | Carbon Solutions Inc. | 1.13 |

The methods used to determine the amount of carboxylic acid covalently attached are described below.

The Titrimetric Determination of Strong Acid Levels in Single-Walled Carbon Nanotubes

A nonaqueous titration procedure is given for the determination of strong acid in Single-Walled Carbon Nanotubes (SWCNT). Samples are dispersed in a solvent system of 50/2 (v/v) distilled tetrahydrofuran (THF)/methanol. The dispersion is titrated with 0.1 N hexadecyltrimethylammonium hydroxide (HDTMAH). Typically two end points are recorded. The first is due to stronger acids associated with the SWCNT. These may be residual mineral acid from the surface derivatization reactions or acid functions attached to the SWCNT surface. A second end point is also observed but is typically too noisy to be utilized quantitatively. The strong acid in the SWCNT sample is subtracted from the total acids found by sodium hydroxide back titration to give the net level of carboxylic acid in the SWCNT.

Equipment

1) Metrohm Model 716 Titrino with Brinkmann Titrino Workcell software, or equivalent, and equipped with a 1-ml amberized glass buret.
2) Indicator electrode—combination glass pH/Ag/AgCl reference. Metrohm Model

6.0202.100, or equivalent. The filling solution for the electrode is 0.1N tetramethyl-ammonium chloride in methanol.

Reagents

1) 0.1 N Hexadecyltrimethylammonium hydroxide (HDTMAH) in ˜9:1 (v) toluene: methanol (Note 1).
2) Distilled tetrahydrofuran (THF) (Note 2)
3) Methanol, reagent grade such as J. T. Baker 9093-33.
   Procedure
1) Weigh to the nearest 0.1 mg approximately 30 to 150 mg of the SWCNT sample into a 100 ml beaker (Note 3).
2) Add 50 ml distilled THF and 2 ml methanol.
3) Cover with Parafilm and stir for 15 minutes.
4) Titrate the sample with 0.1N HDTMAH utilizing the Titrino equipped with a 1 ml buret.
5) Titrate a blank of 50/2 THF/MeOH under the same conditions.
   Calculations
   The Titroprocessor will mark the potentiometric end point(s) automatically. Only the first end point (positive HNP) is used in the following calculation. Subsequent end points are ignored.
   EP=End Point
   Strong Acid(meq/g)=[(ml EP #1)−(ml Blank)]×N_{HDTMAH}(grams of sample)
   Net Carboxylic Acid(meq/g)=[Total Acids (from NaOH Back−Titration) (meq/g)]−[Strong Acid(meq/g)]
   Notes
1) HDTMAH is available as a 25% (w/v) solution in methanol from Acros Organics. Cat # 41142-1000. This material normally needs extensive purification before it is suitable for titrimetric use.
2) THF is distilled to remove the peroxide inhibitor BHT, which interferes with the titration. Distilled THF is a potential peroxide-former and should not be stored for more than 24 hours. Under no circumstances should distilled THF be allowed to evaporate to dryness as the residue is potentially explosive. We have found distillation through a 1 foot Vigreaux column sufficient to remove BHT.
3) Sample sizes vary widely depending on the expected level of carboxylation on the SWCNT sample. The sample range specified is based on experience thus far.
   The Titrimetric Determination of Total Acid Levels in Single-Walled Carbon Nanotubes
   An aqueous titration procedure is given for the determination of total acid in Single-Walled Carbon Nanotubes (SWCNT). Samples are dispersed in water containing an excess of 0.1N NaOH. After sufficient time to react any acid on the SWCNT the excess base is titrated with 0.1N HCl to a potentiometric end point. A blank of 0.1N NaOH without the SWCNT is determined with 0.1N HCl. The total level of acid in the SWCNT sample follows from the difference between the blank and the sample titrations.
   Equipment
1) Metrohm Model 716 Titrino with Brinkmann Titrino Workcell software, or equivalent, and equipped with a 1-ml glass buret.
2) Indicator electrode—combination glass pH/Ag/AgCl reference. Metrohm Model

6.0202.100, or equivalent. The filling solution for the electrode is saturated KCl.

Reagents

1) 0.1 N HCl in water. Standardized against 4-aminopyridine (Primary Standard Grade).
2) 0.1N NaOH. Standardized against benzoic acid (Primary Standard Grade).
   Procedure
1) Weigh to the nearest 0.1 mg approximately 30 to 150 mg of the SWCNT sample into a 100 ml beaker (Note 1).
2) Add 50 ml distilled water.
3) By Class A pipet add 1.0 ml 0.1N NaOH.
4) Cover with Parafilm and stir for two hours.
5) Titrate the sample with 0.1N HCl utilizing the Titrino equipped with a 1 ml buret.
6) Titrate a blank of 1.0 ml 0.1N NaOH in 50 ml distilled water under the same conditions.
   Calculations
   The Titroprocessor will mark the potentiometric end point(s) automatically. Generally two end points will be seen in both the sample and the blank. The difference between the first end points (hydroxide) should be used in the following calculations.
   Total Acids(meq/g)=[(ml HCl at EP #1 Blank)−(ml HCl at EP #1 Sample)]×N_{HCl}(grams of sample)
   Notes
1) Sample sizes vary widely depending on the expected level of carboxylation on the SWCNT sample. If known one can calculate an appropriate sample size. If not known one will have to experiment. The sample range specified is based on our experience thus far.
   Table 2 below shows the dispersion stability/quality found for the various dispersion types formed where only the functionalized tubes in deionized water are used to form the dispersion. It clearly indicates that with a suitable level of carboxylic acid functionalization, the dispersion quality and ability at higher loadings is significantly improved. The legend is as follows, where the numerical value assigned has better dispersion properties as it approaches 10:
   Poor (numerical value 0-2): SWCNTs do not disperse at the given conditions; settling is immediate or after only 1-2 minutes of sitting. A dispersion does not form.
   Marginal (numerical value 3-5): SWCNTs disperse at very low concentrations (<100 ppm) reasonably well but form dispersions at higher concentrations that are not stable over a short period of time. Large particles do not disperse and settle rapidly.
   Good (numerical value 6-8): SWCNTs disperse at low to moderate concentrations reasonably well but do not form stable dispersions at higher concentrations (>1000 ppm). Over time, settling is apparent.

Excellent (numerical value 9-10): SWCNTs disperse at low to moderate to high concentrations (100-5000 ppm) very well and form stable dispersions over the range for several months. At intermediate concentrations (700-2000 ppm), low settling does occur over several months period. At the higher concentrations (3000-5000 ppm), moderate settling does occur as small particles over several months period.

TABLE 2

| | Wt Percent | | | |
|---|---|---|---|---|
| SWCNT Type | 100 ppm | 500 ppm | 1000 ppm | 5000 ppm |
| HiPCO | Poor (1) | Poor (0) | Poor (0) | Poor (0) |
| P2 | Marginal (4) | Poor (2) | Poor (0) | Poor (0) |
| RFP | Good (8) | Marginal (3) | Poor (1) | Poor (0) |
| P3 | Excellent | Excellent | Excellent (9) | Good (8) |
| | (10) | (10) | | |

### EXAMPLES

Preparation of Dispersions Comprising Functionalized SWCNTs without the Use of Surfactant or Dispersant Aids

### Example 1

A coating composition comprised of 1000 ppm (1 mg/mL=0.1 wt %) P3 SWCNTs with 2-2.5 atomic percent carboxylic acid functionalization and the balance of deionized water was prepared in a glass container. Mechanical and acoustic energy were applied to the dispersion. The resultant dispersion is opaque when viewed in the glass container. Over several months, the dispersion was found to remain stable and the dispersion quality was judged as Excellent as defined in Table 2 above.

### Comparative Example 1

A coating composition comprised of 1000 ppm (1 mg/mL=0.1 wt %) CNI HiPCO SWCNT (batch XD3347B) with less than 0.2 atomic percent carboxylic acid functionalization and the balance of deionized water was prepared in a glass container. Mechanical and acoustic energy were applied to the dispersion. The resultant dispersion is transparent due to severe flocculation of the SWCNTs. Over a very short time (minutes), the dispersion was found to form strong aggregates of SWCNTs that would not disperse under additional mechanical or acoustic agitation means. It was not possible to produce a film via conventional coating methods with this coating composition.

### Example 2

A coating composition comprised of 2000 ppm (2 mg/mL=0.1 wt %) P3 SWCNTs with 2-2.5 atomic percent carboxylic acid functionalization and the balance of deionized water was prepared in a glass container. Mechanical and acoustic energy were applied to the dispersion. The resultant dispersion is opaque when viewed in the glass container. Over several months, the dispersion was found to remain stable.

### Example 3

The dispersion in Example 2 was used to make a conductive coating. TX-100 nonionic surfactant was added at 25 wt % based on the weight of the SWCNTs as a coating aid. The coating composition was applied onto a 100 μm thick polyester substrate and dried at 80° C. The dried coating contained 64.6 mg/m² carboxylic acid functionalized SWCNTs and 16.5 mg/m² TX-100 and had a surface resistivity as measured with a 4-point probe equal to 2300 Ω/square. The conductive layer had a transparency of 81.5% at 535 nm wavelength.

### Example 4

The dispersion in Example 2 was used to make a conductive coating. TX-100 surfactant was added at 25 wt % based on the weight of the SWCNTs as a coating aid. The coating composition was applied onto a 100 μm thick polyester substrate and dried at 80° C. The dried coating contained 129 mg/m² carboxylic acid functionalized SWCNTs and 32.3 mg/m² TX-100 and had a surface resistivity as measured with a 4-point probe equal to 840 Ω/square.

It is clear that, for the same SWCNT solids levels, all comparative examples demonstrate poor to no dispersion capability compared to the compositions of the invention with increased functionalization. Likewise, it is clear that, for the same SWCNT solids loadings, all examples with functionalization atomic percent greater than 1% demonstrate low SER values as compared to the compositions of the comparative examples which were not able to produce coatings due to the inferior dispersion quality. These results surprisingly demonstrate the superiority of the compositions of the invention as they provide elevated SWCNT solids levels and capability to coat via conventional means high conductivity, high transparency coatings, compared to the compositions of the prior art and comparative examples It is also clear that with the increased level of functionalization, there is a dramatic increase in the dispersability of the SWCNTs and the resultant SER properties of the coated film are significantly lower than a system with much lower level of surface functionalization applied by a conventional coating method. Hence, the desirability of the coating compositions of the invention is obvious.

### PARTS LIST

10 item for resistive-type touchscreen
12 transparent substrate
14 first conductive layer
15 flexible substrate
16 transparent cover sheet
18 second conductive layer
20 first conductive layer
22 spacer element
30 light-modulating liquid crystal layer
35 nanopigmented functional layer
40 second conductive layer
42 dielectric layer
44 conductive row contacts
50 LCD item
60 display component
62 substrate
64 electronically conductive polymer layer
66 power source
68 electric lead
101 substrate
103 anode
105 hole-injecting layer
107 hole-transporting layer
109 light-emitting layer
111 electron-transporting layer
113 cathode
250 voltage/current source
260 electrical conductors

1. A coating composition comprising an aqueous dispersion of single wall carbon nanotubes with covalently attached hydrophilic species selected from the group consisting of carboxylic acid, nitrates, hydroxyls, sulfur containing groups, carboxylic acid salts, and phosphates, in an amount of at least 0.5 atomic % of said carbon nanotubes, wherein said carbon nanotubes are present in an amount of at least 0.05 wt. % of said dispersion.

2. The coating composition of claim 1 wherein the pH of said dispersion is between 3 and 10.

3. The coating composition of claim 1 wherein the pH of said dispersion is between 3 and 6.

4. The coating composition of claim 1 wherein said carbon nanotubes are present in an amount of between 0.05 and 10% of said dispersion.

5. The coating composition of claim 1 wherein said carbon nanotubes are present in an amount of between 0.05 and 1% of said dispersion.

6. The coating composition of claim 1 wherein the hydrophilic species is present in an amount of between 0.5 and 5 atomic %.

7. The coating composition of claim 1 wherein said hydrophilic species comprises carboxylic acid or carboxylic acid salt or mixtures thereof.

8. The coating composition of claim 1 wherein said hydrophilic species comprises a sulfur containing group selected from:
SOₓZ_{y}
Wherein x may range from 1-3 and Z may be a Hydrogen atom or a metal cation such metals as Na, Mg, K, Ca, Zn, Mn, Ag, Au, Pd, Pt, Fe, Co and y may range from 0 or 1.

9. The coating composition of claim 1 wherein said carbon nanotubes have an outer diameter of between 0.05 and 5 nanometers.

10. The coating composition of claim 1 wherein said carbon nanotubes comprise bundles of a diameter of between 1 and 50 nanometers.

11. The coating composition of claim 1 wherein said carbon nanotubes comprise bundles of a diameter of between 1 and 20 nanometers.

12. The coating composition of claim 1 wherein said carbon nanotubes have a length of between 20 nanometers and 50 microns.

13. The coating composition of claim 1 wherein said carbon nanotubes comprise bundles of a length of between 20 nanometers and 50 microns.

14. The coating composition of claim 1 wherein said carbon nanotubes are metallic carbon nanotubes.

15. The coating composition of claim 1 wherein said hydrophilic species comprises sulfonic acids or sulfonic acid salts or mixtures thereof.

16. The coating composition of claim 1 wherein said carbon nanotubes are open end carbon nanotubes.

17. The coating composition of claim 1 wherein said covalently attached hydrophilic species is present on the outside wall of said carbon nanotube.

18. The coating composition of claim 1 wherein said carbon nanotubes have a hexagonal configuration of carbon atoms.

19. The coating composition of claim 1 wherein said dispersion further comprises a polymeric binder.

20. The coating composition of claim 1 wherein said dispersion is substantially free of single wall carbon nanotube dispersants.

21. An article comprising a transparent carbon nanotube layer comprising single wall carbon nanotubes with covalently attached hydrophilic species selected from the group consisting of carboxylic acid, nitrates, hydroxyls, sulfur containing groups, carboxylic acid salts, and phosphates, in an amount of at least 0.5 atomic % of said carbon nanotubes.

22. The article of claim 21 further comprising a substrate of carrying said carbon nanotube layer.

23. The article of claim 21 further comprising a binder in said carbon nanotube layer.

24. The article of claim 21 wherein said carbon nanotube layer has an electronic conductivity of between 100 and 10,000 Siemens per cm.

25. The article of claim 21 wherein said carbon nanotube layer has a thermal conductivity of between 100 and 3,000 watts per meter Kelvin.

26. The article of claim 21 wherein said carbon nanotube layer has a thickness of between 1 nanometer and 1 micron.

27. The article of claim 21 wherein the hydrophilic species is present in an amount of between 0.5 and 5 atomic %.

28. The article of claim 21 wherein said hydrophilic species comprises carboxylic acid or carboxylic acid salts or mixtures thereof.

29. The article of claim 21 wherein said hydrophilic species comprises sulfonic acid or sulfonic acid salts or mixtures thereof.

30. The article of claim 21 wherein said carbon nanotubes have an outer diameter of between 0.05 and 5 nanometers.

31. The article of claim 21 wherein said carbon nanotubes comprise bundles of a diameter of between 1 and 50 nanometers.

32. The article claim 21 wherein said carbon nanotubes comprise bundles of a diameter of between 1 and 20 nanometers.

33. The article of claim 21 wherein said carbon nanotubes have a length of between 20 nanometers and 50 microns.

34. The article of claim 21 wherein said carbon nanotubes comprise bundles of a length of between 20 nanometers and 50 microns.

35. The article of claim 21 wherein said carbon nanotubes are metallic carbon nanotubes.

36. The article of claim 21 wherein said carbon nanotube layer has a transparency of between 75-99%

37. The article of claim 21 wherein said carbon nanotubes are open end carbon nanotubes.

38. The article of claim 21 wherein said carbon nanotube layer comprises between 0 and 1 percent by weight of single wall carbon nanotube dispersants.

39. A display device comprising a substrate, an electrically conductive transparent carbon nanotube layer on a surface of said substrate, and a lead electrically connected to said conductive layer, wherein said conductive layer comprises single wall carbon nanotubes with covalently attached hydrophilic species selected from the group consisting of carboxylic acid, nitrates, hydroxyls, carbonyls, and phosphates, in an amount of at least 0.5 atomic % of said carbon nanotubes.

40. The display device of claim 39 further comprising a current source connected to said conductive layer.

41. The display device of claim 39, wherein a liquid crystalline material is in contact with said conductive layer either directly or through a dielectric passivating layer.

42. The display device of claim 39, further comprising a voltage source electrically connected to said conductive layer.

43. The display device of claim 39, wherein said conductive layer forms a pattern on the surface of the substrate.

44. The display device of claim 39, wherein said substrate is selected from the group consisting of polyethyleneterephthalate, polyethylenenaphthalate, polycarbonate, glass, and cellulose acetate.

45. The display device of claim 39, wherein said substrate is flexible.

46. The display device of claim 39 further comprising at least one electrically imageable layer.

47. The display device of claim 39 wherein said electrically imageable material comprises light modulating material.

48. The display device of claim 47 wherein said light modulating material comprises at least one member selected from the group consisting of electrochemical, electrophoretic, electrochromic and liquid crystals.

49. The display device of claim 46 wherein said electrically imageable material comprises light emitting material.

50. The display device of claim 49 wherein said light emitting material comprises organic light emitting diodes or polymeric light emitting diodes.

51. The display device of claim 47 wherein said light modulating material is reflective or transmissive.
